(19) United States
(12) Patent Application Publication
(10) Pub. No.: US 2021/0317702 A1
(43) Pub. Date: Oct. 14, 2021

(54) OPERATION DEVICE FOR SHUTTERS AND METHOD FOR MAKING THE SAME

(71) Applicant: WEN YING LIANG, Changhua County (TW)

(72) Inventor: WEN YING LIANG, Changhua County (TW)

(21) Appl. No.: 17/023,061

(22) Filed: Sep. 16, 2020

(30) Foreign Application Priority Data
Apr. 10, 2020 (CN) 202020517707.0

(51) Int. Cl. E06B 9/303

(52) U.S. Cl. CPC E06B 9/303

(57) ABSTRACT

A method for manufacturing an operation device for shutters includes a step of forming a ladder a step of forming a receiving element, a cord accommodated in the receiving element, and a step of connecting multiple connecting elements to the ladder and the receiving element. The operation device for shutters includes a ladder, a receiving element accommodating a cord therein, and the connecting elements connected to the ladder and the receiving element.

### BACKGROUND OF THE INVENTION

### 1. Fields of the Invention

The present invention relates to shutters, and more particularly, to an operation device of shutters and a method for making the operation device.

### 2. Descriptions of Related Art

The conventional shutters as shown in FIG. 9, include multiple slats 1a, two ladders 2a, a cord 3a, a top rail 4a, a bottom rail 5a and a scrolling member 6a. The ladders 2a support the slats 1a between the top and bottom rails 4a, 5a. The cord 3a controls the ladders 2a to lift or lower the slats 1a. The cord 3a and the ladders 2a are connected to the scrolling member 6a. It is noted that the cord 3a is exposed and may tangle limbs such as hands, legs or even neck accidentally.

Some shutters have loops attached to the ladders, and the cord extends through the loops to avoid children from playing the cord. However, it consumes a lot of time during assembling steps. In addition, the cord can be pulled out from the loops. Some shutters include ladders with the receiving elements integrally formed with the ladders. Again, it involves a complicated manufacturing processes. Once one of the receiving element, the ladder or the cord needs to be replaced, the whole combination has to be replaced.

The present invention intends to provide an operation device of shutters and a method for making the operation device, so as to eliminate the shortcomings mentioned above.

### SUMMARY OF THE INVENTION

The present invention relates to a method for manufacturing an operation device for shutters, and the method comprises a step (a): forming a ladder; a step (b): forming a receiving element, a cord accommodated in the receiving element, and a step (c): connecting multiple connecting elements to the ladder and the receiving element.

Preferably, the cord is accommodated in the receiving element when making the receiving element in the step (b).

Preferably, the cord is accommodated in the receiving element after the receiving element is manufactured in the step (b).

Preferably, the receiving element is made of transparent material.

Preferably, the connecting elements are sewed to the ladder and the receiving element, or the connecting elements extend through the ladder and the receiving element. The connecting elements are located with a distance formed between each other.

Preferably, the receiving element, the cord and the connecting elements have different colors or an identical color.

The present invention also provides an operation device for shutters, and comprises a ladder, a receiving element accommodating a cord therein, and multiple connecting elements connected to the ladder and the receiving element to combine the cord and the ladder.

Preferably, the receiving element and the ladder each have holes. The connecting elements extend through the holes of the receiving element and the ladder.

Preferably, the connecting elements are sewed to the receiving element and the ladder.

Preferably, the ladder, the receiving element, the cord and the connecting elements have different colors or materials, or the ladder, the receiving element, the cord and the connecting elements have an identical color or material.

The present invention further provides a shutter and comprises an operation device having a ladder, a receiving element, a cord, multiple connecting elements and a scrolling member. The receiving element accommodates the cord therein. The connecting elements are connected to the ladder and the receiving element. The operation device supports multiple slats between a top rail and a bottom rail. The operation device is connected to the scrolling member. A control member is connected to the cord. The control member controls the cord to lift or lower the slats.

The primary object of the present invention is to provide an operation device for shutters, and the operation device is easily manufactured and maintained.

The cord and the ladder of the present invention are assembled as a one-piece to avoid the cord from tangling.

The operation device has better structural strength which provides stronger support to the slats.

The operation device allows the users to easily replace the cord. The components of the operation device may have different colors or materials to meet aesthetic purposes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the operation device of the present invention installed to a shutter;

FIG. 2 is an enlarged view to show the ladder of the operation device of the present invention;

FIG. 3A shows the receiving element accommodates the cord of the operation device of the present invention;

FIG. 3B is an enlarged view to show a section of the receiving element that accommodates the cord of the operation device of the present invention;

FIG. 4 shows that the connecting elements connecting the receiving element;

FIG. 5 illustrates a front view of the shutter with the operation device of the present invention installed thereto;

FIG. 6 illustrates a front view of another shutter with the operation device of the present invention, wherein the shutter includes multiple slats;

FIG. 7 is a side view to show the operation device of the present invention installed to the shutter;

FIG. 8 shows that a new cord is tied to the original cord of the shutter; and

FIG. 9 shows a conventional shutter.

### DETAILED DESCRIPTION OF THE PREFERRED EMBODIMENT

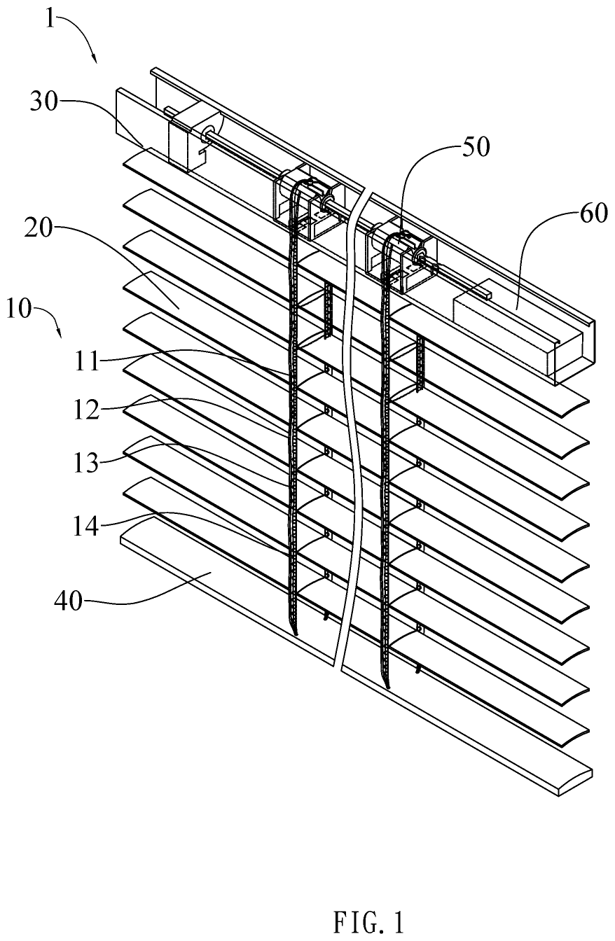

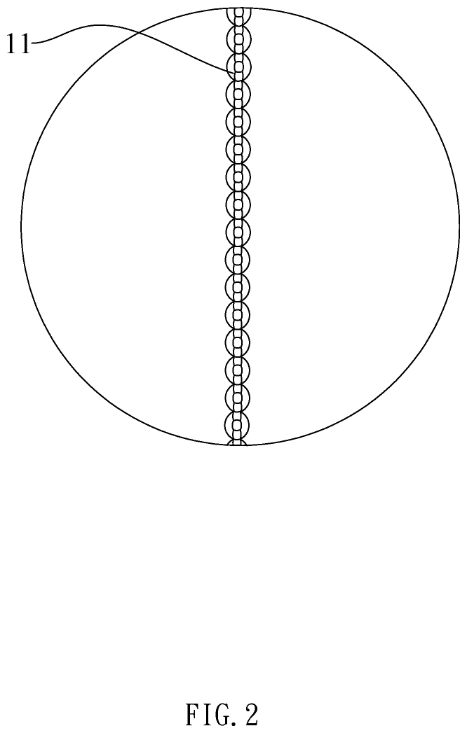

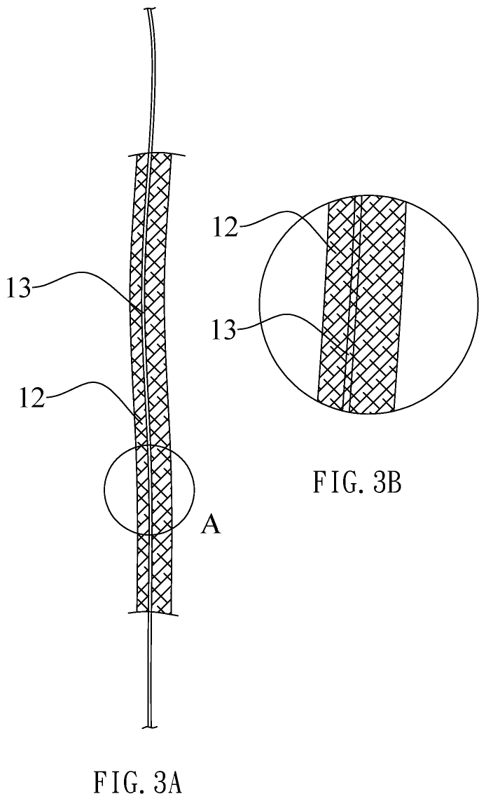

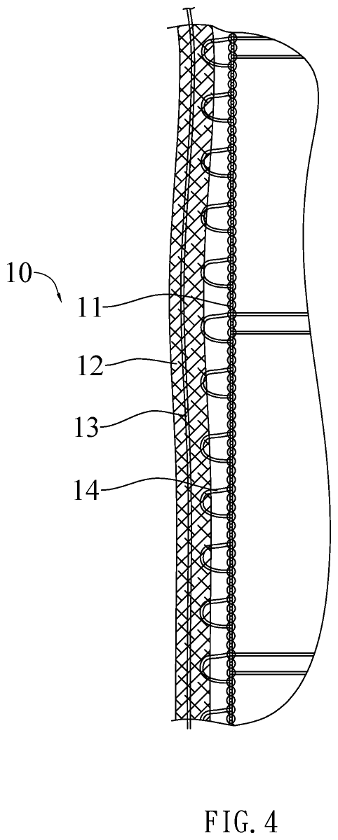

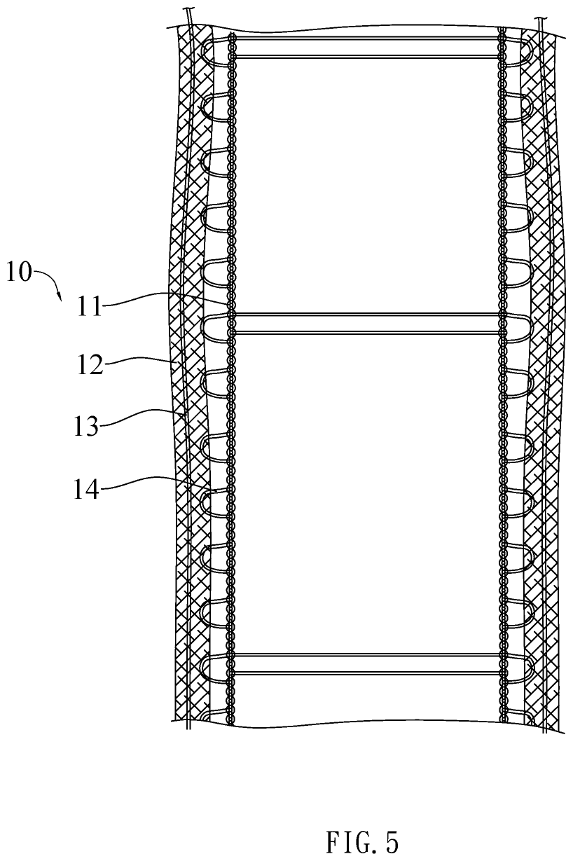

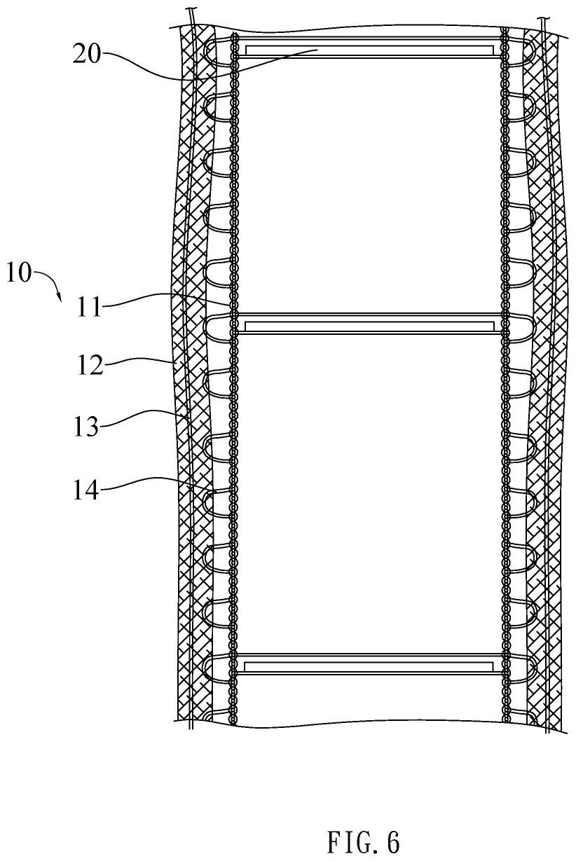

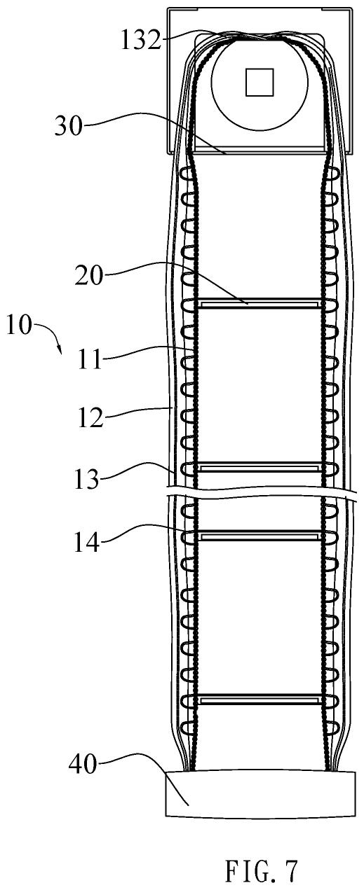

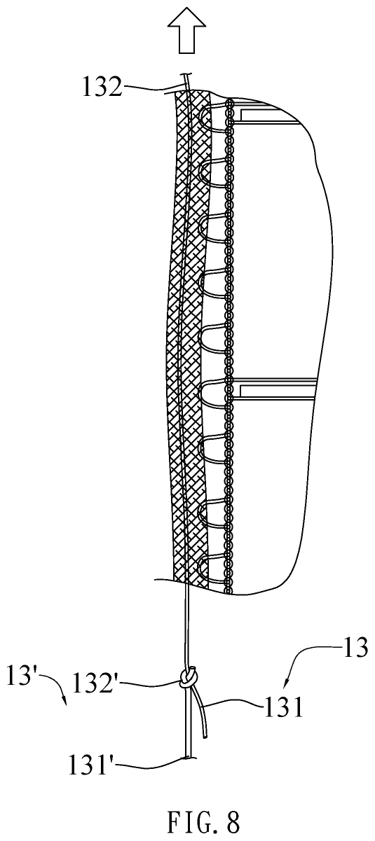

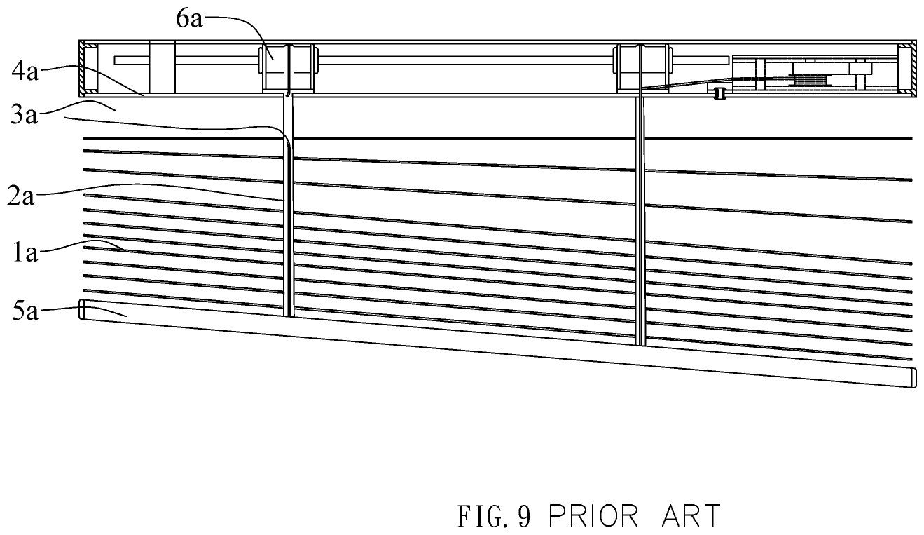

Referring to FIGS. 1 to 8, the operation device 10 of the present invention comprises a ladder 11, a receiving element 12, a cord 13 and multiple connecting elements 14. The receiving element 12 accommodates the cord 13 therein. The connecting elements 14 are connected to the ladder 11 and the receiving element 12 to combine the cord 13 and the ladder 11. In other words, the ladder 11, the receiving element 12, the cord 13 and the connecting elements 14 each are a module, and these modules are assembled as needed to easily assemble the operation device 10. Each of the modules has different colors so as to meet aesthetic purposes.

The receiving element 12 can be a netted element or an enclosed and soft element. If the receiving element 12 is a netted element, the cord 13 can be seen via the netted structure, and the cord 13 cannot be pulled out from the netted element. If the receiving element 12 is an enclosed and soft element, the cord 13 cannot be seen. The cord 13 is accommodated in the receiving element 12 when making the receiving element 12. Alternatively, the cord 13 is accommodated in the receiving element 12 after the receiving element 12 is manufactured. It is noted that the connecting elements 14 can directly extend through the ladder 11 and the receiving element 12. That is to say, the receiving element 12 and the ladder 11 each have holes, so that the connecting elements 14 extend through the holes of the receiving element 12 and the ladder 11. Alternatively, the connecting elements 14 may be sewed to the ladder 11 and the receiving element 12 when the receiving element 12 and the ladder 11 do not have holes. The material and color of the ladder 11, the receiving element 12 the cord 13 and the connecting elements 14 can be varied as needed. When the ladder 11 or the receiving element 12 needs to be replaced, the connecting elements 14 are removed first, and the ladder 11 or the receiving element 12 can be replaced.

The shutter 1 of the present invention comprises at least one operation device 10, multiple slats 20, a top rail 30, a bottom rail 40, at least one scrolling member 50 and at least one control member 60. The operation device 10 supports the multiple slats 20 between the top rail 30 and the bottom rail 40. The operation device 10 is connected to the scrolling member 50. The cord 13 is connected to the control member 60, and the control member 60 controls the cord 13 to lift or lower the slats 20. The operation device 10 hides the cord 13 to make the shutter be safer than the conventional shutters. The operation device 10 is easily to be manufactured and assembled. The operation device 10 may have at least one scrolling spring to control the cord 13.

When replacing the cord 13, the connection end 132 of the new cord 13′ is tied to the distal end 131 of the original cord 13. The connection end 132 of the original cord 13 is pulled so as to introduce the new cord 13′ into the receiving element 12. The connection end 132′ of the new cord 13′ is then connected to the scrolling member 50, and the distal end 131′ of the new cord 13′ is fixed to the bottom rail 40. The original cord 13 can be replaced with the new cord 13′ which can be thicker or thinner than the original cord 13.

The method for manufacturing the operation device 10 for shutters 1 of the present invention comprises:

a step (a): forming a ladder 11;

a step (b): forming a receiving element 12, a cord 13 accommodated in the receiving element 12, and

a step (c): connecting multiple connecting elements 14 to the ladder 11 and the receiving element 12.

The ladder 11 supports and controls the slats 20 to rotate. The cord 13 is accommodated in the receiving element 12 when making the receiving element 12 in the step (b). Alternatively, the cord 13 is accommodated in the receiving element 12 after the receiving element 12 is manufactured in the step (b).

The receiving element 12 can be a netted element or an enclosed and soft element. The receiving element 12 can be made of transparent material.

The connecting elements 14 are sewed to the ladder 11 and the receiving element 12, or the connecting elements 14 extend through the ladder 11 and the receiving element 12 with a distance formed between any adjacent connecting elements 14.

The receiving element 12, the cord 13 and the connecting elements 14 have different colors or an identical color.

It is noted that the sequence of the step (b) and the step (c) of the method of the present invention can be changed. The step (b) is proceeded before the step (c) can simplify the manufacturing. If step (c) is proceeded before the step (b), the connecting elements 14 do not penetrate through the cord 13 or press the cord 13.

While we have shown and described the embodiment in accordance with the present invention, it should be clear to those skilled in the art that further embodiments may be made without departing from the scope of the present invention.

What is claimed is:

1. A method for manufacturing an operation device for shutters, comprising:
a step (a): forming a ladder;
a step (b): forming a receiving element, a cord accommodated in the receiving element, and
a step (c): connecting multiple connecting elements to the ladder and the receiving element.

2. The method as claimed in claim 1, wherein the cord is accommodated in the receiving element when making the receiving element in the step (b).

3. The method as claimed in claim 1, wherein the cord is accommodated in the receiving element after the receiving element is manufactured in the step (b).

4. The method as claimed in claim 1, wherein the receiving element is made of transparent material.

5. The method as claimed in claim 1, wherein the connecting elements are sewed to the ladder and the receiving element, or the connecting elements extend through the ladder and the receiving element, the connecting elements are located with a distance formed between each other.

6. The method as claimed in claim 1, wherein the receiving element, the cord and the connecting elements have different colors or an identical color.

7. An operation device for shutters, comprising:
a ladder;
a receiving element accommodating a cord therein, and
multiple connecting elements connected to the ladder and the receiving element to combine the cord and the ladder.

8. The operation device as claimed in claim 7, wherein the receiving element and the ladder each have holes, the connecting elements extend through the holes of the receiving element and the ladder.

9. The operation device as claimed in claim 7, wherein the connecting elements are sewed to the receiving element and the ladder.

10. The operation device as claimed in claim 7, wherein the ladder, the receiving element, the cord and the connecting elements have different colors or materials, or the ladder, the receiving element, the cord and the connecting elements have an identical color or material.

11. A shutter comprising:
an operation device having a ladder, a receiving element, a cord, multiple connecting elements and a scrolling member, the receiving element accommodating the cord therein, the connecting elements connected to the ladder and the receiving element, the operation device supporting multiple slats between a top rail and a bottom rail, the operation device connected to the scrolling member, and
a control member connected to the cord, the control member controlling the cord to lift or lower the slats.
